(19) United States
(12) Patent Application Publication
(10) Pub. No.: US 2003/0182557 A1
(43) Pub. Date: Sep. 25, 2003

(54) Device for activating user-specific settings

(76) Inventor: Pettit Roderick, Wantirna (AU)

Correspondence Address: KENYON & KENYON, ONE BROADWAY, NEW YORK, NY, 10004, US

(21) Appl. No.: 10/297,953

(22) PCT Filed: Mar. 20, 2002
(86) PCT No.: PCT/DE02/01003

(30) Foreign Application Priority Data
Apr. 12, 2001 (DE) 101 18 339.9

(51) Int. Cl. H04L 9/00

(52) U.S. Cl. 713/182

(57) ABSTRACT

A device for activating a user-specific settings is proposed. It includes at least one fingerprint sensor (10), whose sensor signal (12) is compared by a signal analysis (16) for user identification to at least one reference information (U1REF, U2REF, UNREF). At least one setting (E1, E2) of an adjustable component (24) is assigned to at least one user. A control (20) activates the adjustable component (24) along the lines of the setting (E1, E2) assigned to the recognized user. Detection means (10, 14) are provided which detect the presence of a finger on the fingerprint sensor (10), the adjustable component (24) being activated depending on whether the presence of a finger is detected.

### BACKGROUND INFORMATION

The present invention is directed to a device for activating user-specific settings according to the definition of the species in the independent claim. From the EP-A 924 123, a device is already known for activating specific user-dependent settings of rearview-mirror actuator drives, seat-adjuster drives, air-conditioner settings or radio settings. The user identification is accomplished with the aid of a fingerprint sensor. If the particular user is verified via the fingerprint system, the settings of the comfort and convenience functions assigned to this user are automatically activated. However, to rule out dangerous situations during the adjustment procedures, one must be able to reliably deactivate or interrupt such procedures.

The object of the present invention is to undertake a simple deactivation of the adjustment procedures in the context of a fingerprint sensor system. This object is achieved by the features of the independent claim.

### SUMMARY OF THE INVENTION

The device according to the present invention for activating user-specific settings includes at least one fingerprint sensor, whose sensor signal is compared by a signal analysis for user identification to at least one reference information. At least one setting of an adjustable component is assigned to at least one user. A control is provided which activates the adjustable component along the lines of the setting assigned to the recognized user. In accordance with the present invention, detection means are provided which detect the presence of a finger on the fingerprint sensor, the adjustable component being activated depending on whether the presence of a finger is detected. With the aid of detection means, it is possible to immediately stop the adjusting procedure for the adjustable component when the finger is no longer situated on the fingerprint sensor. In this manner, adjustment procedures that endanger safety may be immediately interrupted.

As a detection means, one expedient refinement provides for accessing the evaluation of the sensor signal of the fingerprint sensor. Since the fingerprint sensor is already provided in any case for identifying users and for activating the user-dependent settings, there is no longer a need for additional hardware for the detection means. Using appropriate evaluation algorithms, it is ascertained whether the finger is at all still situated on the fingerprint sensor. This evaluation logic is already present for purposes of user identification. Thus, this device is distinguished by an inexpensive and uncomplicated type of construction.

One useful embodiment provides for a capacitive sensor as detection means. It detects changes in capacitance which occur as a function of the presence of the finger and which are used by a downstream evaluation electronics for detecting the presence. It is not necessary for the capacitive sensor to be directly touched by the user.

In another useful embodiment, the detection means is implemented by a switch that is actuatable by the finger. Such a test switch is able to be simply integrated in the fingerprint sensor. This detection system has a very high level of reliability.

Other useful embodiments are derived from additional dependent claims and from the description.

### BRIEF DESCRIPTION OF THE DRAWING

An exemplary embodiment of the device according to the present invention is shown in the drawing and is described in greater detail in the following.

FIG. 1 shows a block diagram of the device according to the present invention; and

FIG. 2 a flow chart illustrating the operating method of the device according to the present invention.

### DESCRIPTION OF THE EXEMPLARY EMBODIMENT

A fingerprint sensor 10 transmits a sensor signal 12 and a switch signal 13 to a signal evaluation 14. Stored in signal evaluation 14 is a reference list 15, in which a first reference information U1REF identifying a first user is filed at the first position; a second reference information U2REF identifying a second user at the second position; and an n-th reference information UNREF identifying an n-th user at the n-th position. As an output signal, signal evaluation 14 transmits a user information 16 and a finger-presence signal 18 to a control, designated in the following as comfort-and-convenience control unit 20. Comfort-and-convenience control unit 20 has a memory 21 for user settings. For the first user or the corresponding first reference information U1REF, a first setting E1 is stored; for the second user or the corresponding second reference information U2REF, a second setting E2 is stored, and so forth. Moreover, four signals of a control element 22 are relayed to comfort-and-convenience control unit 20. Comfort-and-convenience control unit 20 generates suitable control signals for actuating drives 24 as an example of components which are adjustable as a function of the particular user.

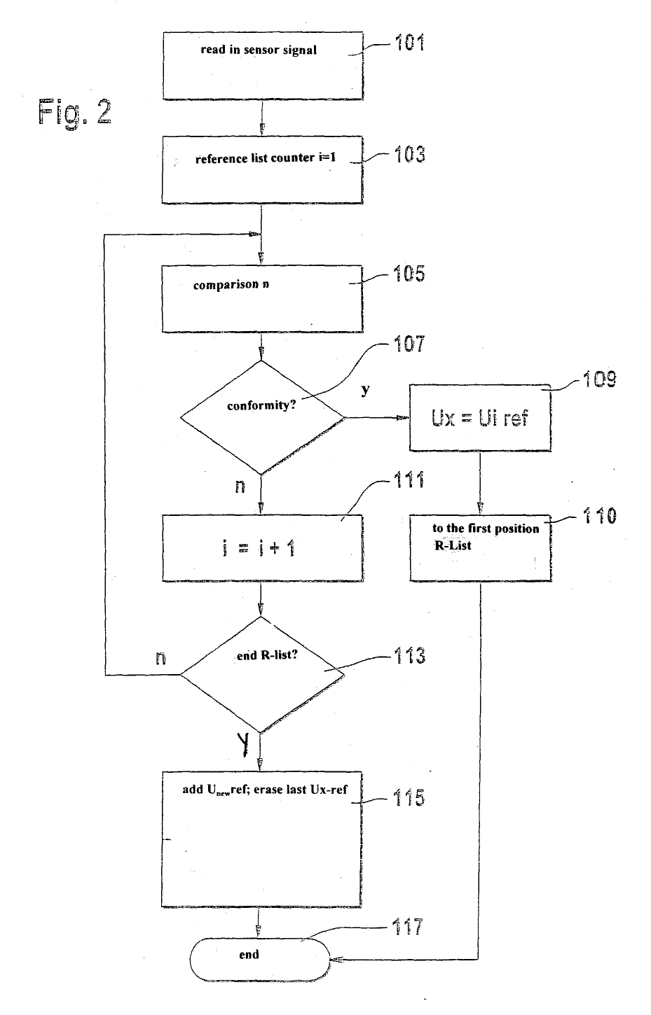

Fingerprint sensors 10 detect the typical characteristics of a fingerprint, for example using optical or capacitive techniques. The corresponding sensor signal 12 is processed by signal evaluation 14, in accordance with the method described in FIG. 2. In a step 101, sensor signal 12 is read in. A number of users are known in advance to the system on the basis of the reference information U1REF, U2REF, UN-REF. At this point, signal evaluation 14 determines whether input sensor signal 12 may be assigned to an already known user on the basis of reference information U1REF, U2REF, UNREF. For this purpose, signal evaluation 14 compares sensor signal 12 with the first element of reference list 15, namely first reference information U1REF. Corresponding reference list counter i is at position 1 (i=1), step 103. This is followed by the comparison between sensor signal 12 and reference information UiREF in step 105. If no conformity of sensor signal 12 with the first reference information U1REF (i=1) is ascertained, reference list counter i is raised by 1, step 111. For as long as the end of the reference list is not yet reached, as ascertained in query 113, steps 105, 107 and 111 are run through in succession. Thus, sensor signal 12 is compared in succession to reference information U1REF through UNREF stored in reference list 15. If the end of reference list 15 is reached, as ascertained in query 113, input sensor signal 12 is stored as new reference information UNEUREF and added to reference list 15, step 115. The new user was, in fact, not known to the system. However, he/she is accepted as a new user without further verification. If all memory locations of reference list 15 are already written with reference information, last reference information UNREF is erased, step 115. The procedure for learning about a new user is carried out without an additional criterion.

For the case that conformity is ascertained between sensor signal 12 and one of reference information U1REF, U2REF, UNREF in step 107, signal evaluation 14 uniquely assigns a specific user to sensor signal 12 on the basis of reference information U1REF, U2REF, UNREF, step 109. Reference information UXREF determined in this manner is transmitted as user information 16 to comfort-and-convenience control unit 20.

Moreover, in step 110, reference list 15 may be resorted in order to accelerate the next user identification. In this case, different procedures are conceivable. Thus, reference list counter i could be set to the last identified reference information UXREF for the next identification procedure. Consequently, signal evaluation 14 would compare new sensor signal 12 to be read in with the last reference information UXREF that generated a conformity check. The frequency of detected users may be used as another way to influence reference list 15. With each conformity of reference information with sensor signal 12, a counter assigned to this reference information is incremented. Thus, this counter is a measure of the frequency of use. Reference list 15 is now sorted according to frequency, i.e., the reference information having the highest frequency is set to first position, and so forth. In the new identification procedure, signal evaluation 14 now first compares sensor signal 12 to the reference information occupying the first position of reference list 15, thus to that reference information registering the greatest occurrences of use. This increases the probability that a frequent user is quickly recognized again. The frequency of use may also be used as a criterion for determining which reference information should be erased in response to the appearance of a new user profile and limited memory location. In this case, the reference information having the lowest frequency of use is removed. This makes it possible to minimize the number of new users to be programmed.

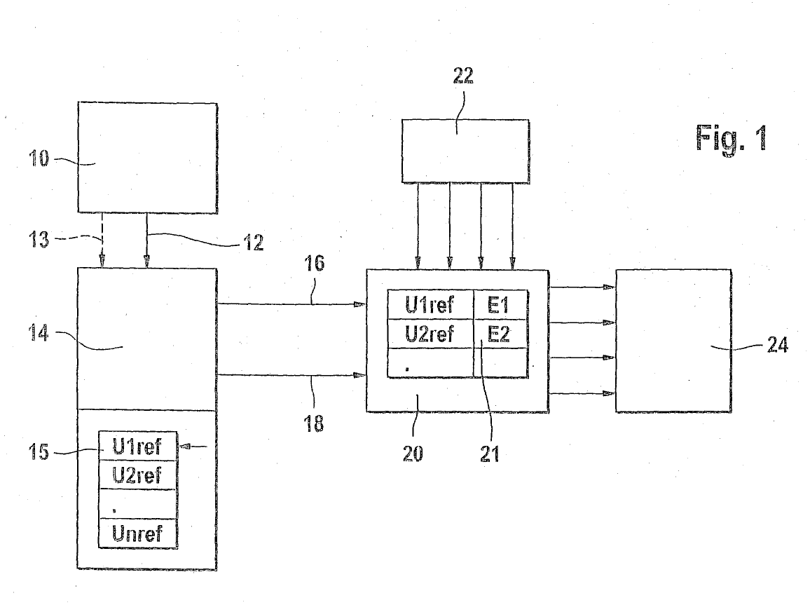

As user information 16, signal evaluation 14 transmits first reference information U1REF conforming with sensor signal 12. Comfort-and-convenience control unit 20 receives user information 16 and searches in memory 21 for the user setting to determine whether transmitted user information 16 is present there in the form of reference information U1REF. In the exemplary embodiment according to FIG. 1, first setting E1 is assigned to first reference information U1REF; second setting E2 to second reference information U2REF. Comfort-and-convenience control unit 20 reads out this first setting E1 and activates actuating drives 24 along the lines of this first setting E1. Actuating drives 24 may, for example, move the driver or passenger seat of a motor vehicle into the position indicated by first setting E1. Actuating drives 24 could also be used to adjust interior and/or exterior mirrors or dimming devices. However, it is not absolutely necessary for comfort-and-convenience control unit 20 to drive actuating drives 24. Settings E1, E2 for air-conditioning units or radio-control units could also be provided, for example, to activate specific interior temperatures that the user had stored during the last control operation, or to select radio stations preset in dependence upon the user. However, these are only mentioned by way of example as possible settable components.

In accordance with the present invention, detections means 10, 14 are provided which detect the presence of a finger on fingerprint sensor 10. In a first alternative, the detection means are implemented by fingerprint sensor 10 and signal evaluation 14. Signal evaluation 14 continually checks sensor signal 12 supplied by fingerprint sensor 10 to determine if it conforms with any pattern characteristic of a finger presence on fingerprint sensor 10. As long as this is the case, signal evaluation 14 transmits a finger-presence signal 18 to comfort-and-convenience control unit 20. Finger-presence signal 18 has a binary state. For example, it has the value logic one when signal evaluation 14 detects the presence of a finger on the basis of the pattern comparison. Comfort-and-convenience control unit 20 now utilizes this finger-presence signal 18 to inhibit the corresponding driving of actuating drives 24 using an AND operation. The activation of actuating drives 24 is only permitted for as long as finger-presence signal 18 has the value logic one and thereby indicates that a finger is still situated on fingerprint sensor 10. If the user removes his/her finger from fingerprint sensor 10, then signal evaluation 14 detects this immediately and, as a result, changes finger-presence signal 18 from logic one to logic zero. The activation of actuating drives 24 is immediately stopped by the AND gating of the activation signal for actuating drives 24 with finger-presence signal 18. For purposes of finger-presence detection, it is not necessarily required that the detected sensor signal of control element 22 exactly conform with reference information stored in reference list 15. As a result, the processing time of the finger-presence detection may be shortened. If the finger is again placed on fingerprint sensor 10, the activation of actuating drives 24 is initiated again along the lines of the preceding setting E1. If indicated, this process continues until actuating drives 24 have reached setting positions E1, E2 predefined as reference values.

As a further alternative detection means for the presence of a finger, one could also use a capacitive sensor placed in the proximity of fingerprint sensor 10. Depending on the distance of the finger from the capacitive sensor, its total capacitance is influenced as a function of the distance. If the finger distances itself too far from the capacitive sensor, this is recognized on the basis of the capacitance evaluation, and, in response thereto, finger-presence signal 18 changes accordingly to the state logic zero.

As another alternative finger-detection means, a switching contact may be provided which is able to be activated by fingerprint sensor 10. If the user places his/her finger on fingerprint sensor 10, then he/she actuates this switching element at the same time. The output signal from this switching element arrives, in turn, as finger-presence signal 18 at comfort-and-convenience control unit 20. This finger-presence signal 18 is further processed in the manner already described.

Alternatively, provision may be made for only certain adjustable components, such as seat-adjustment drives, to be movable with the finger situated on fingerprint sensor 10. For other components, however, the continuous presence of a finger is not required to activate user-dependent settings E1, E2.

What is claimed is:

1. A device for activating user-specific settings,
comprising at least one fingerprint sensor (10), whose sensor signal (12) is compared by a signal analysis (14) for user identification to at least one reference information (U1REF, U2REF, UNREF),
at least one setting (E1, E2) of an adjustable component (24) being assigned to at least one user,
and at least one control (20) which activates the adjustable component (24) along the lines of the setting (E1, E2) assigned to the recognized user,
wherein detection means (10, 14) are provided which detect the presence or proximity of a finger on the fingerprint sensor (10), the adjustable component (24) being activated depending on whether the presence of the finger is detected.

2. The device as recited in claim 1,
wherein the activation of the adjustable component (24) along the lines of the setting (E1, E2) assigned to the user is stopped as soon as the finger is no longer detected as being present on or in the proximity of the fingerprint sensor (10).

3. The device as recited in one of the preceding claims,
wherein the detection means (10, 14) accesses the evaluation of the sensor signal (12) of the fingerprint sensor (10).

4. The device as recited in one of the preceding claims,
wherein a capacitive sensor is used as the detection means (10).

5. The device as recited in one of the preceding claims,
wherein a switching element that is actuatable by a finger is used as detection means.

6. The device as recited in one of the preceding claims,
wherein the switching element is integrated in the fingerprint sensor (10).

7. The device as recited in one of the preceding claims,
wherein a plurality of reference information (U1REF, U2REF, UNREF) is provided.

8. The device as recited in one of the preceding claims,
wherein that reference information (U1REF, U2REF, UNREF), which first conformed with the sensor signal (12) during a preceding comparison, is first compared with the sensor signal (12).

9. The device as recited in one of the preceding claims,
wherein that reference information (U1REF, U2REF, UNREF), which most frequently conformed with the sensor signal (12) during a preceding comparison with the sensor signal (12), is first compared with the sensor signal (12).
